(19) United States
(12) Patent Application Publication
(10) Pub. No.: US 2009/0298370 A1
(43) Pub. Date: Dec. 3, 2009

(54) Flame Retardant Fabrics

(75) Inventor: Moshe Rock, Brookline, MA (US)

Correspondence Address: FISH & RICHARDSON PC, P.O. BOX 1022, MINNEAPOLIS, MN, 55440-1022, US

(73) Assignee: MMI-IPCO, LLC, Lawrence, MA (US)

(21) Appl. No.: 12/132,126

(22) Filed: Jun. 3, 2008

(51) Int. Cl. D04B 21/00; D03D 7/00; B05D 3/00

(52) U.S. Cl. 442/136; 427/322

(57) ABSTRACT

A fabric article of knitted or woven construction with flame retardant, interlaced yarns has a pile, raised or fleece region on its inner surface and a flame retardant coating on its outer surface. The flame retardant coating provides both flame retardancy and improved durability against pilling and fraying without substantial adverse effect on characteristics of the base fabric. A method of forming the fabric article is also described.

### TECHNICAL FIELD

This invention relates to flame retardant fabrics.

### BACKGROUND

Fabrics for clothing, such as jackets and other outer wear, with qualities desired for use during exercise or exertion, especially warmth and breathability may be formed, e.g., by circular knit plaited construction or circular knit reverse plaited construction, or with a woven or warp knit construction. Fabrics formed in this manner typically have a relatively smooth outer surface (the “technical face”) and an inner surface (the “technical back”) that can be raised, e.g. by processes such as napping, brushing, sanding, etc., to form an insulating layer of fleece. Unfortunately, in both knit constructions, the durability of the smooth technical face is often inferior to many woven constructions, limiting their use in articles of apparel intended for harsher outdoor sports. In particular, the fuzziness of the smooth technical face will often have an inferior aesthetic look, as well as poor technical features. The smooth face also tends to pill in specific areas of a garment, e.g. at the elbows or at the shoulders, under the straps of a backpack.

### SUMMARY

According to one aspect of the invention, a fabric article of knitted or woven construction comprises a fabric body of yarns comprising flame retardant material, the fabric body having has an inner surface and an outer surface. The inner surface has at least one region of pile or raised fibers or fleece formed thereupon, and the outer surface is treated with a flame retardant coating, to provide both a desirable level of flame retardancy and enhanced durability of the outer surface against pilling or fraying during use.

In some embodiments, & discontinuous coating of discrete coating segments is applied. The discontinuous coating binds individual yarn fibers together in bound groupings and enhances the abrasion resistance of the outer surface. In some embodiments, the discontinuous coating is without substantial effect on the insulation performance or moisture transmission rate provided by the knit construction of the fabric body.

Preferred embodiments of this aspect of the invention may include one or more of the following additional features. The yarns comprise inherently flame retardant polymer, and/or contain flame retardant additive. The fabric article has plaited circular terry knit construction, reverse plaited circular terry knit construction, double knit construction, single jersey plaited construction, woven construction or warp knit construction. The fabric article is an article of wearing apparel. The fabric comprises multi-filament yarns. The multi-filament yarns are textured or flat. The fabric comprises spun yarns. The yarns comprise fibers formed of materials selected from the group consisting of: aramide, flame retardant polyester, flame retardant rayon, modacrylic, wool cotton, flame retardant treated cotton, polyester and blends thereof. The yarns of the outer surface comprise spandex. Fibers of the multi-filament yarns are highly intermingled at over about 60 tucks per meter (TPM) and preferably at over about 100 TPM or more, or there may be little or no intermingling. The binder material adheres only to yarn fibers in a manner to substantially avoid restriction of air permeability through the fabric article. Alternatively, the binder material comprises a film extending into interstitial air passageways through the fabric article in a manner to reduce air permeability. The coating of binder material does not have a substantial adverse effect on drapability and hand of the fabric article. The fabric article has one or more first regions of enhanced surface durability, e.g., due to relatively greater density of binder or binder dots per unit area applied by engineered pattern printing technology to a fabric web. The fabric article has one or more second regions of relatively lesser surface durability, e.g., due to relatively lesser density of binder or binder dots per unit area applied by engineered pattern printing technology to a fabric web.

According to another aspect of the invention, a method of forming a fabric article comprises the steps of: interlacing flame retardant yarns comprising fibers to form a fabric body of knit or woven construction; forming a raised or fleece region upon an inner surface of the fabric body; and, thereafter, applying a flame retardant material to at least the outer surface to form a flame retardant coating upon at least yarn fibers at interlacing intersections on at least the outer surface of the fabric article, to resist pilling and fraying of yarn fibers at the outer surface.

Preferred embodiments of this aspect of the invention may include one or more of the following additional features. The step of applying a binder material comprises applying by standard printing technology, e.g. by rotary screen roll or by gravure roll. The step of applying a binder material comprises applying the binder material with a pad. The method further comprises removing binder material in liquid state from interstitial spaces of the fabric body in a manner to control reduction of air permeability. The step of removing binder material comprises blowing air through the interstitial spaces or drawing air by suction through the interstitial spaces. The step of applying binder material comprises applying a binder material comprising a binder selected from the group consisting of aramide, flame retardant polyester, flame retardant rayon, modacrylic, wool, cotton, flame retardant treated cotton, polyester and blends thereof, preferably in a form selected from the group consisting of resin, latex, polymer emulsion and polymer dispersion. The step of applying binder material comprises applying a binder material in a liquid carrier and allowing the liquid carrier to evaporate leaving the binder material or applying a binder material in a foam liquid carrier and allowing the foam carrier to collapse leaving the binder material. The step of applying the binder material comprises applying a binder material by engineered pattern printing technology to a fabric web. Preferably, the binder material is applied by engineered pattern printing techniques to form one or more first regions of enhanced surface durability by applying a first pattern with relatively greater density of binder or binder dots per unit area, e.g. to shoulder regions, and to form one or more second other regions of lesser surface durability by applying a second pattern with relatively lesser density of binder or binder dots per unit area, e.g. to body regions.

The invention thus provides a composite fabric article that overcomes recognised deficiencies of fabrics of, e.g., knit construction, in particular when used in garments and other articles for harsher outdoor sports and for applications in which it is desirable that the fabric be flame retardant, without detracting significantly from qualities of the original form of the fabric found highly desirable for use during exercise or exertion, e.g., warmth, breathability, drapability, MVT, hand tactile, etc. Furthermore, improved fabric articles have a predetermined, controlled, i.e., limited, degree of air permeability may be formed according to the method of the invention.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 illustrates an embodiment of a fabric article in the form of a jacket.

FIG. 2 illustrates another embodiment of a fabric article in the form of pants.

FIG. 3 is a diagrammatic section view of a knit fabric prebody of a first embodiment having a discontinuous coating.

FIG. 4 is a diagrammatic section view of a knit fabric body formed by finishing the fabric prebody of FIG. 3.

FIG. 5 is a somewhat diagrammatic plan view of the outer surface of a fabric article of the invention, with the binder material for enhanced surface durability against fraying and pilling adhered to yarns and yarns fibers about an interstitial space; and

FIG. 6 is a somewhat diagrammatic plan view of the outer surface of a fabric article of the invention, with the binder material for enhanced surface durability against fraying and pilling adhered to yarns and yarns fibers and also extending into interstitial spaces to increase wind resistance.

Like reference symbols in the various drawings indicate like elements.

### DETAILED DESCRIPTION

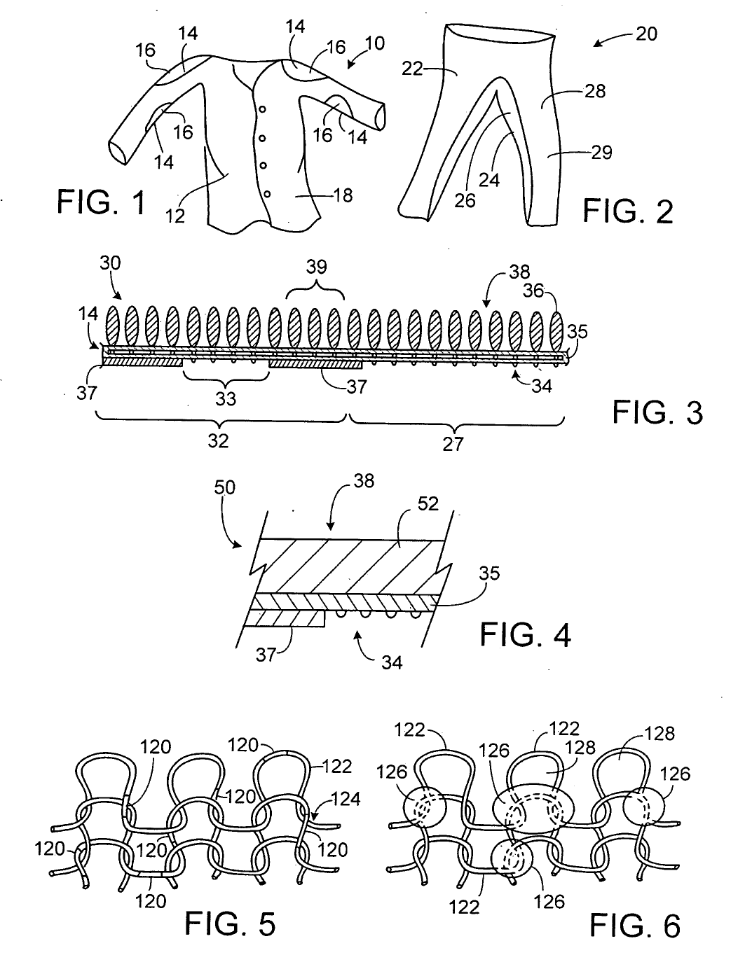

Referring to FIGS. 1 and 2, knit fabric articles 10, 20 of wearing apparel in the form of, by way of examples only, a jacket and pants are formed of an improved composite fabric having controlled air permeability to enhance dynamic insulation and to reduce convective heat loss. The fabrics have relatively smooth outer surfaces 12, 22 upon which flame retardant coatings 14, 24 are adhered, and inner surfaces upon which a raised or insulating fleece is formed. Flame retardant coatings 14, 24, which may be discontinuous, impart flame retardancy and enhance face abrasion resistance and pilling resistance of the resulting fabrics while generating controlled air permeabilities in a predetermined range to facilitate improved levels of moisture vapor transmission (MVT), which is particularly desirable for activities generating high metabolism rates.

Generally, coating 14 can be applied to either the entire outer surface or to selected areas of the outer surface of the fabric article, as desired. Referring particularly to FIG. 1, in a first example, fabric article 10 has coated areas 16 and areas free of coating 18. Areas 16 correspond to regions of finished fabric article 10 that are relatively more prone to abrasion and pilling during use. By applying the coating to these areas of the outer surface, areas 16 exhibit relatively higher levels of abrasion and pilling resistance than areas 18. Areas 18, being substantially free of coating material, have a relatively higher level of air permeability and facilitate a relatively higher moisture vapor transmission rate. As shown, coating 14 is applied, e.g., to areas 16 generally corresponding to the shoulders and elbows.

Referring to FIG. 2, fabric article 20 has areas 26 of discontinuous coating and areas 28 of a continuous coating 29. Discontinuous coating 24 is applied within areas 26 of fabric article 20 corresponding to regions of finished fabric article 20 that are subjected to relatively high perspiration levels during use. Areas 28 having the continuous coating applied to the outer surface have relatively higher abrasion and pilling resistances and relatively lower air permeability levels. Discontinuous coating 24, by being applied in areas 26, facilitates moisture vapor transmission while enhancing the abrasion and pilling resistances. As shown, coating 24 is applied to areas corresponding generally to the inner thighs.

The coating includes flame retardant agent. One example of a suitable flame retardant agent is metal hydrate, for example aluminum hydroxide, also known as aluminum trihydrate (ATH), alumina hydroxide, and alumina trihydrate, and having the chemical formula Al(OH)₃; and magnesium hydroxide, also known as magnesium hydrate and having the chemical formula Mg(OH)₂. Other suitable flame retardant agents include other metal hydrates, and metal hydroxides, such as antimony hydroxide, zinc hydroxide, calcium hydroxide, ammonium molybdate tetrahydrate, barium hydroxide, ceric hydroxide, cesium hydroxide, nickel (II) hydroxide, and strontium hydroxide. The flame retardant agent may also be an antimony compound, such as antimony trioxide, antimony hydrate, sodium antimonate, or antimony pentoxide. The flame retardant agent may be a boron compound, such as zinc borate, boric acid, or borax, or another metal compound such as molybdenum trioxide, ammonium octa molybdate (AOM), zinc stannate, or zinc hydroxyl-stannate. The flame retardant agent may be a char forming material, such as polyacylonitrile; a phosphorus compound, such as red phosphorus or ammonium polyphosphate; or another inorganic flame retardant, such as ammonium sulfamate or ammonium bromide. The flame retardant agent may be a halogenated organic compound, such as tetrabromobisphenol A, octabromobisphenyl ether, decabromodiphynyl ether, bis(tribromophenoxy)ethane, tetrabromobiphenyl ether, hexabromocyclododecane, tribromophenol, bis(tribromophenoxy)ethane, tetrabromobisphenol A polycarbonate oligomer, tetrabromobisphenol A epoxy oligomer, bis(hexacholorcyclopentadieno)cyclo-octane, or cholinated paraffins. The flame retardant agent may be an organophosphorus compound, such as tris(1-chloro-2-propyl)phosphate, tris(2-chloroethyl)phosphate, tris(2,3-dibromopropyl)phosphate, trialkyl phosphate, triaryl phosphate, aryl-alkyl phosphate, flame retardant polyols, phosphonium directivities, or phosphonates. The flame retardant agent may also be a nitrogen-based chemical compound, such as polyurethanes, polyamides, melamine, or guanidine.

The coating may also include other additives that enhance flame retardancy, for example char promoters, catalysts and fillers. Suitable additives are disclosed, for example, in U.S. Patent Publication No. 2007/0190872, the complete disclosure of which is incorporated herein by reference.

The coating also includes a film-forming polymeric binder. Suitable binders include latexes, e.g., acrylic latex, polyurethanes and silicones, and polymers that are inherently flame retardant, e.g., polyvinyl chloride (PVC). When inherently flame retardant binders are used, in some implementations it is not necessary to add the flame retardant additives discussed above to the coating.

The amount of coating material applied depends, at least in part, on the end use of the product. For example, in some cases, it may be desirable to greatly enhance the flame retardancy and/or abrasion resistance of selected areas of the fabric article. In these cases, relatively more coating material can be applied (e.g., the coating may be continuous, or may be discontinuous with a relatively greater number of dots per square inch of fabric material and/or relatively large amount of material per dot). In other cases, it may be desirable for areas of the fabric article to have flame retardancy and enhanced abrasion resistance, while having a relatively high level of air permeability. In these cases, relatively less coating material can be applied (e.g., the coating may be discontinuous, with relatively fewer dots per square inch of material and/or less material per dot). The weight of coating 14, 24 on the printed fabric can be between about 0.5 to about 6.0 oz/sq yd, such as about 1.7 oz/sq yd. The coating 14, 24 can be applied by any suitable method. If the coating is discontinuous, it may be applied by, e.g., rotary printing, kiss rolling, and gravure rolling. In some cases, a discontinuous coating 14 is applied by a single head rotary screen having a selected number of holes per lineal inch (e.g., from about 30 holes per lineal inch to about 195 holes per lineal inch).

In a first example of a fabric article construction, referring particularly to FIG. 3, a knit fabric prebody 30 is formed by joining a stitch yarn 35 and a loop yarn 36 in a standard reverse plaiting circular knitting (terry knitting) process, e.g., as described in Knitting Technology, by David J. Spencer (Woodhead Publishing Limited, 2nd edition, 1996), the entire disclosure of which is incorporated herein by reference. As used herein, the term “fabric prebody” is employed to distinguish the fabric body formed by later process steps. The terms “technical face” and “technical back” generally refer to sides or surfaces of the fabric as it exits the knitting machine. As used herein, the term “technical face” also refers to the outer surface of the finished fabric article (see elements 12, 22 of FIGS. 1 and 2). In the terry knitting process, the stitch yarn 35 forms the technical face 34 of the resulting fabric prebody 30 and the loop yarn 36 forms the opposite technical back 38, where it is formed into loops 39. In the fabric prebody 30, the loop yarn 36 extends outwardly to overlie and cover the stitch yarn 35 at the technical face 34.

Referring to FIG. 3, knit fabric prebody 30 includes coating 14 formed of multiple, spaced apart or discontinuous coating segments 37 applied within an area 32 of technical face 34. In the embodiment shown in FIG. 3, discontinuous coating 14 is applied to only portions of knit fabric prebody 30 leaving area 27 substantially free of discontinuous coating 14. In some cases, however, area 27 can have a continuous coating applied thereon. Coating 14 is discontinuous within area 32 of technical face 34, and can be applied in a predetermined pattern (e.g., lines, dots, etc.), leaving portion 33 of the technical face free of the coating material within area 32 adjacent coating segments 37. The coating material forming coating segments 37 is generally air impermeable or semi impermeable, while within portion 33, the fabric prebody remains air permeable to allow air passage through the composite fabric at controlled rates.

Once the fabric prebody is formed, referring to FIG. 4, fabric prebody 30 (FIG. 3) is subjected to finishing to form fabric body 50. During the finishing process, the technical back 38 of fabric prebody 30 goes through a finishing process, such as sanding, brushing and/or napping, to generate a raised surface 52, such as a fleece or velour, as examples. Raised surface 52 can be finished to a predetermined height depending on the application for which the composite fabric will ultimately be used. Controlling the height of raised surfaces 52 allows for different levels of insulation to be generated. Typically, the greater the height of the raised surface, the more insulation the fabric will provide. In some cases, fabric prebody 30 may be finished prior to application of coating 14. Fabric prebody 30 may also be treated, e.g., chemically, to make it hydrophobic.

After finishing, fabric body 50 is heat set to stabilize the fabric article width. Heat may be applied to the fabric body, e.g. dry heat or wet heat, such as hot water or steam, e.g. during finishing or dyeing. This can be done before and/or after the coating is deposited.

In addition to providing controlled air permeability, the coating material binds yarn fibers, thereby improving other certain structural and physical properties of the composite fabric. For example, in binding the individual fibers using the coating material, the fibers form bound fiber groupings (e.g., of at least about 5 fibers, of at least about 20 fibers, of at least about 35 fibers, of at least about 70 fibers, from about 2 to about 100 fibers) and the tenacity of these groupings of fibers (e.g., from about 140 to about 350 grams per denier for a grouping of about 70 fibers) is greater than the tenacity of each individual fiber (e.g., from about 2 to about 5 grams per denier). Also, by coating and binding yarn fibers together with coating material within region 32, the abrasion and pilling resistances within the region is enhanced, thus improving the abrasion and pilling resistances of the composite fabric.

Pilling resistance within coated regions 32 of the composite fabric can be as high as five on a scale from one to five measured by ASTM D-3512. Face abrasion resistance of the composite fabric within coated regions 32 can be as high as five on a scale from one to five after 250 cycles measured by ASTM D-3884 and using a Martindale abrasion machine where the abrasion is done by a VELCRO® hook touch fastener tape mounted on the Martindale testing unit.

In binding fibers of the yarn, coating 14 also provides greater freedom of yarn selection in the construction of the fabric prebodies. In some embodiments, coating 14 facilitates use of relatively finer fibers (e.g., less than 5.0 dpf, less than 1 dpf, less than 0.5 dpf, less than 0.2 dpf, from about 0.1 dpf to about 5.0 dpf) in the construction of the prebodies, e.g., by reducing the risk of the fibers being pulled from the technical face. By utilizing finer fibers, a tighter stitch can be achieved, which, in turn, improves the dynamic insulating performance of the resultant fabric, e.g., by providing relatively narrow air passageways through the fabric and increasing the tortuosity through those passageways. In certain embodiments, coating 14, in binding fibers in the yarn of the fabric prebody, allows use of relatively weaker fibers, such as polyester and nylon in the construction of the prebodies, which also provides greater tortuosity of air passageways to enhance dynamic insulation performance of the fabric.

The stitch yarn and/or the loop yarn include flame retardant material. Preferred yarns include inherently flame retardant fibers and yarns such as M-Aramide, Modacrylic, Modacrylic/cotton, and the like. These yarns are generally spun yarns. Other suitable yarns include fibers and yarns treated with flame retardant chemical. In some implementations both the stitch yarn and the loop yarn are either inherently flame retardant or treated with flame retardant chemical.

In some implementations, the stitch yarn comprises heat sensitive material and the loop yarn comprises flame retardant material. Flame retardant fabrics of this type are described in, e.g., U.S. Pat. No. 6,828,003, the entire disclosure of which is incorporated herein by reference.

In one embodiment, the stitch yarn includes, or consists largely of, yarn or filaments of heat sensitive material, e.g. heat shrinkable material, or hot melt material (typically commingled (e.g., blended) with other fiber that will maintain yarn integrity after heat treatment). The loop yarn, which may be filament yarn but is more typically spun yarn, includes, or consists largely of, fibers of Inherently flame retardant material, e.g., such as m-Aramide, e.g., 1.5 denier fibers. Such fibers are manufactured, for example, by E. I. du Pont de Nemours and Company, of Wilmington, Del., under the trademark NOMEX®. The m-Aramide fibers may be used alone, or in a blend, e.g. with fibers of p-Aramide, e.g. as manufactured by E. I. du Pont de Nemours and Company, under the trademark KEVLAR®, and/or with fibers of other suitable material having good electrostatic dissipation characteristics. Suitable heat sensitive materials include polypropylene, nylon, polyester, polyamide, and the like, preferably with relatively high shrinkage, e.g., about 5% to about 50% after about 2 minutes to about 60 minutes at about 212° F. to about 450° F. Heat is thereafter applied to the fabric article, e.g., dry heat and/or wet heat, such as hot water or steam, e.g. during dyeing and/or finishing. Upon exposure to heat, the hot melt material fuses to narrow or fill interstices between the yarns filaments, and the heat shrinkable material shortens and thickens, and/or reduces in effective length, thus to reduce the paths for passage of chilling wind through the fabric and thereby increase the tortuosity and the dynamic insulation performance of the fabric article.

In some embodiments, the stitch yarn comprises cored yarn having a core formed, e.g., of polyester or nylon, with a sheath formed of heat sensitive material, e.g., hot melt material, such as polypropylene, polyester or nylon, e.g. as available commercially from Engineered Yarn Company, of Fall River, Mass. The loop yarn includes, or consists largely of, fibers of flame retardant material. During heating of the fabric article of this embodiment, e.g. during dyeing and/or finishing, the hot melt material of the sheath fuses, thus increasing the tortuosity and further reducing the paths for passage of chilling wind through the fabric and improving the dynamic insulation performance of the fabric article.

However, the loop yarn 36 forming the technical back 38 of the knit fabric body 30 can be made of any synthetic or natural material. The cross section and luster of the fibers or the filament may be varied, e.g., as dictated by requirements of the intended end use. The loop yarn 16 can be textured or flat filament yarn, with textured yarn being preferred. In some embodiments, the loop yarn has relatively finer dpf (e.g., at most about 0.2 to about 1.5 dpf) than the stitch yarn (e.g., about 2.0 dpf), allowing a tighter stitch (e.g., using a 235-inch per revolution, 28 cut, 26-inch cylinder knitting machine) for greater dynamic insulating effect. The loop yarn overall denier is preferably in the range of about 70 denier to 300 denier, such as about 150 denier. At the preferred count, the filament count range is from about 100 filaments to about 400 filaments. A preferred commercial loop yarn is a 2/70/200 filament with a dpf of 0.3, e.g., as available from Unifi Inc.

The stitch yarn 14 forming the technical face 16 of the knit fabric body 12 can also be made of any type of synthetic or natural material in textured or flat micro-denier filament yarn, with a textured yarn being preferred. In preferred embodiments, stitch yarn 35 is coarser (e.g., at least about 1.5 dpf, such as about 2.0 dpf) than loop yarn 36, as noted above. The range of stitch yarn count overall denier is preferably between about 50 denier to 150 denier. At the preferred count, the filament count range is from about 24 filaments to about 100 filaments. A preferred stitch yarn is 70/34, e.g. as available commercially from Unifi Inc.

In another example, the fabric upon which a surface of enhanced durability is to be formed has a warp knit construction, e.g. as described in U.S. Pat. No. 6,196,032, issued Mar. 6, 2001, and U.S. Pat. No. 6,199,410, issued Mar. 13, 2001, the complete disclosures of which are incorporated herein by reference. Still other examples of suitable processes for forming fabric prebodies with inherent wind breaking properties include circular knit with perfect plaiting and double needle bar warp knit, both of which are described in, e.g., Knitting Technology. Coating 14 can be applied to both wind resistant and non wind resistant constructions to enhance pilling and abrasion resistances.

In any of the above knit constructions, elastic yarn may be added (e.g., spandex such as Lycra® or Lycra® T-400) to, e.g., the stitch yarn. In some cases, the stitch yarn is formed of elastic material. In certain cases, elastomeric yarn can be wound about the stitch yarn and/or the elastomeric yarn can be added to the stitch yarn in plaited form and/or air cover. In some embodiments, stitch yarn may include an elastic core yarn. The elastomeric materials in the stitch yarn can provide relatively greater densification and tortuosity, and therefore increased dynamic insulation performance for enhanced protection from wind penetration, as well as providing for fabric stretch and enhanced wearer comfort.

Referring to FIG. 5, in some embodiments regions 120 of flame retardant coating are adhered primarily to yarn fibers 122 and at interlacing intersections of yarns 124, thereby allowing the fabric to retain its original form and characteristics, including good drapability and hand, and allowing through-passage of air to a predetermined degree (MVT and breathability), but also providing an outer surface of enhanced durability e.g. against pilling and wear, e.g. during exercise and harsher outdoor sports. In some implementations, the binder for forming a surface region of enhanced durability surface is applied to the outer surface of the fabric article with a pad. In this embodiment, in order to reduce the tendency toward fraying while maintaining a high level of moisture vapor transmission, good drapability, hand and soft touch, deposit of the binder material is preferably limited primarily to the fibers and/or to the intersections of fibers in the yarn segments, and formation of binder film in the interstitial spaces between yarns is minimized. The formation of film may particularly be avoided by removal of excess liquid binder from interstitial spaces between yarns shortly following application, e.g. while the binder material is still wet or moist, by air suction or air blowing through the fabric article.

Preferably, in these implementations, the binder material is applied in a low viscosity system, or in a system with a relatively low level of binder solids or particulates in a liquid carrier, so that as the system dries, the liquid carrier evaporates (or in a foam system, collapses), leaving the solid binder deposited primarily or only on the yarns or yarn fibers. In this manner, the air permeability level and other characteristics of the base fabric are maintained.

Referring to FIG. 6, in other embodiments the binder material forms a film 126 that constricts (but preferably does not block) interstitial spaces 128 between yarns 122, thereby to reduce air-permeability and provide increased insulation and warmth, for use in particular under colder and windier conditions.

In these implementations, binder material of relatively higher viscosity may be employed, to encourage formation of a fine film in the interstitial areas between yarns that will partially or fully maintain its integrity during the drying process. In this manner, the fabric article may be provided with increased water repellency and wind resistance, which would be advantageous in cold windy ambient environments. However, a full or continuous film is typically to be avoided, in order to maintain at least a minimum desired degree of moisture vapor transmission necessary for comfort during high energy activities, such as naming, skiing, etc.

A number of embodiments of the invention have been described. Nevertheless, it will be understood that various modifications may be made without departing from the spirit and scope of the invention.

The coating may be applied in other configurations, for example as discussed below. As another example (not shown), the discontinuous coating is applied in areas of the fabric article subjected to relatively high levels of wind impact (e.g., the chest of a shirt or jacket). Areas having the discontinuous coating have improved wind resistance due to the selected application of the coating material.

Moreover, other aesthetic effects may be applied face side to back side, including, e.g., color differentiation and/or patterning on one or both surfaces, including three dimensional effects. The fabric article may have one-way or two-way stretch, and/or the fabric may be constructed to provide a degree of stretch from any of a broad range, including from very low stretch (very stable) or high stretch or compression power stretch. The binder material may be applied in other fashions as appropriate, e.g. by kiss coating or froth foam application, preferably to the technical face after raising the technical back. In other applications, the binder material may also be deposited, e.g., by pad application, upon both surfaces of the fabric article, including, e.g., upon a raised or fleece surface. The multi-strand or multi-filament yarn may, e.g., have the form of staple fibers in spun yarn or filaments in continuous yarn, or the fabric may be constructed with a combination of spun yarn, staple fibers and continuous filament yarn. In addition to suction and blowing of air through the fabric article during drying, the degree of film formation may also be controlled, e.g., by crushing the coated fabric between nip rollers.

Accordingly, other embodiments are within the scope of the following claims.

What is claimed is:

1. A fabric article of knitted or woven construction, the fabric article comprising:
a fabric body of interlaced yarns comprising flame retardant material, the fabric body having an inner surface and an outer surface, the inner surface having at least one region of pile or raised fibers or fleece formed thereupon, and the outer surface having a flame retardant coating adhered to the yarns and/or to fibers of the yarns at least at interlacing intersections, for durability of the outer surface against pilling or fraying during use.

2. The fabric article of claim 1 wherein the yarns comprise inherently flame retardant polymer and/or contain flame retardant additive.

3. The fabric article of claim 1, wherein the fabric article has plaited circular terry knit construction.

4. The fabric article of claim 1, wherein the fabric article has reverse plaited circular terry knit construction.

5. The fabric article of claim 1, wherein the fabric article has double knit construction.

6. The fabric article of claim 1, wherein the fabric article has single jersey plaited construction.

7. The fabric article of claim 1, wherein the fabric article has a woven construction.

8. The fabric article of claim 1, wherein the fabric article has a warp knit construction.

9. The fabric article of claim 1 in the form of an article of wearing apparel.

10. The fabric article of claim 1, wherein the yarns are textured.

11. The fabric article of claim 1, wherein the yarns are flat.

12. The fabric article of claim 2, wherein the yarns comprises fibers formed of materials selected from the group consisting of: aramide, flame retardant polyester, flame retardant rayon, modacrylic, wool, cotton, flame retardant treated cotton, polyester and blends thereof.

13. The fabric article of claim 2, wherein the yarns comprises fibers formed of non-melt, no drip materials.

14. The fabric article of claim 1, wherein the yarns of the outer surface comprise spandex.

15. The fabric article of claim 1, wherein the yarns comprise spun yarns.

16. The fabric article of claim 1, wherein in at least one region of the fabric article the coating is discontinuous.

17. The fabric article of claim 1, wherein the yarns comprise multi-filament yarns.

18. The fabric article of claim 1, wherein the coating adheres only to yarn fibers in a manner to substantially avoid restriction of air permeability through the fabric article.

19. The fabric article of claim 1, wherein the coating comprises a film extending into interstitial air passageways through the fabric article in a manner to reduce air permeability.

20. The fabric article of claim 1, wherein the coating is without substantial adverse effect on drapability and hand of the fabric article.

21. The fabric article of claim 1, wherein the fabric article has one or more first regions of enhanced surface durability due to relatively greater density of binder in said first regions.

22. The fabric article of claim 21, wherein the fabric article has one or more second regions of relatively lesser surface durability due to relatively lesser density of binder in said second regions.

23. A method of forming a fabric article, said method comprising the steps of:
interlacing flame retardant yarns to form a fabric body of knit or woven construction;
forming a raised or fleece region upon an inner surface of the fabric body; and, thereafter,
applying a flame retardant coating material to at least the outer surface to form a coating upon at least yarn fibers at interlacing intersections on at least the outer surface of the fabric article, to resist pilling and fraying of yarn fibers at the outer surface.

24. The method of claim 23, further comprising removing coating material in liquid state from interstitial spaces of the fabric body in a manner to control reduction of air permeability.

25. The method of claim 23, wherein the step of applying coating material comprises applying a coating material comprising a binder selected from the group consisting of aramide, flame retardant polyester, flame retardant rayon, modacrylic, wool, cotton, flame retardant treated cotton, polyester and blends thereof.

26. The method of claim 25, wherein the binder is in a form selected from the group consisting of resin, latex, polymer emulsion and polymer dispersion.

27. The method of claim 23, wherein the fabric article is formed of a knit construction with a technical face defining the outer surface and a technical back defining the inner surface, and the method further comprises raising the technical back and thereafter applying the coating material to the technical face.
